(19) United States
(12) Patent Application Publication
(10) Pub. No.: US 2006/0114388 A1
(43) Pub. Date: Jun. 1, 2006

(54) Polarising liquid crystal device for security documents

(76) Inventor: Gary Fairless Power, Victoria (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/517,562

(22) PCT Filed: Jun. 12, 2003
(86) PCT No.: PCT/AU03/00730

§ 371 Date: Dec. 7, 2004

(30) Foreign Application Priority Data
Jun. 18, 2002 (AU) PS 3019

(51) Int. Cl. G02F 1/1337

(52) U.S. Cl. 349/125

(57) ABSTRACT

A polarizing liquid crystal device comprises a substrate, at least one photo-alignment layer which is uniformly aligned with a polarized light source and a nematic liquid crystal later applied to the photo-alignment later. A latent image which is viewable under cross-polarizers is formed by the photo-alignment layer and the liquid crystal later without the aid of a mask by a variable printing or laser writing process.

This invention relates to liquid crystal devices and is particularly concerned with polarising liquid crystal devices suitable for incorporation in security documents and methods for their manufacture.

The use of different forms of liquid crystals, both nematic and cholesteric, as security devices has previously been proposed. For example, U.S. Pat. No. 5,602,661 discloses an optical component which has an orientation layer comprising a photo-orientable polymer network (PPN) in contact with a film of cross-linked nematic liquid crystal monomers with varying local orientation of the liquid crystal molecules. The liquid crystal monomers are oriented by interaction with the PPN layer and the orientation is fixed in a subsequent cross-linking step.

U.S. Pat. No. 6,160,597 discloses an optical component comprising a stack of alternating PPN orientation layers and liquid crystal monomer (LCP) layers on a single substrate, the LCP layers being cross-linked to fix the orientation of the component.

The optical components of U.S. Pat. No. 5,602,661 and U.S. Pat. No. 6,160,597 have various uses, including liquid crystal cells in integrated optical devices, and as security devices for use as a safeguard against counterfeiting and copying.

It is possible to form images which are detectable when viewed under cross-polarizers using a photo-alignment layer, such as the PPN orientation layers of U.S. Pat. No. 5,602,661 and U.S. Pat. No. 6,160,597, coupled with a nematic liquid crystal layer applied to its surface. However, this has previously required separate exposures to polarised light having different directions of polarisation and the use of a mask to cover different regions of the orientation layer during each exposure.

A disadvantage of the use of photo-alignment with a mask to form a latent image is that it is not possible to form an image which can be readily varied for different documents, e.g. a coded or personalised image, such as a portrait of an individual.

U.S. Pat. No. 5,678,863 discloses a means of identification or a document of value which has a cholesteric liquid crystal material applied to a watermark in a transparent or translucent region so that the watermark changes colour under different viewing conditions. In order to form an image in a different colour, it is necessary to use two cholesteric liquid crystals which are chosen so as to produce alternatively right and left polarising light. A layer formed from such liquid crystals is quite thick and the liquid crystal materials are relatively expensive. Such a latent image is only circularly polarising in reflection and requires a circular polariser for viewing the colour changing effect.

It is therefore desirable to provide a polarising liquid crystal device which can be used to form variable latent images that can be readily varied for incorporation in different security devices and security documents.

It is also desirable to provide relatively simple and effective methods of manufacturing such polarising liquid crystal devices for forming a latent image in a security document.

According to one aspect of the invention, there is provided a liquid crystal device comprising: a substrate; at least one photo-alignment layer applied to the substrate and which is uniformly aligned with a polarised light source; a nematic liquid crystal layer applied to the photo-alignment layer; and a latent image formed by the photo-alignment layer and the liquid crystal layer without the use of a mask, wherein the latent image is viewable under cross-polarisers.

Preferably, at least one of the at least one photo-alignment layer and/or the liquid crystal layer is a printed layer. The printed layer or layers may be applied to the substrate by a variable printing process, for example using ink jet printing or other variable printing technology which allows a latent image to be formed in the at least one photo-alignment layer and/or in the liquid crystal layer. Alternatively, the latent image may be written into the at least one photo-alignment layer and/or the liquid crystal layer, e.g. by a variable laser writing process.

According to a second aspect of the invention, there is provided a method of manufacturing a liquid crystal device comprising:

applying at least one photo-alignment layer to a substrate;

uniformly aligning the photo-alignment layer with a polarised light source;

applying a liquid crystal layer to the photo-alignment layer; and

forming a latent image is formed in the at least one photo-alignment layer and/or the liquid crystal layer without the use of a mask.

Preferably, the latent image is formed in the at least one photo-alignment layer and/or the liquid crystal layer by printing the image in at least one of said layers.

In a first embodiment, the latent image may be at least partly formed by applying the liquid crystal layer to a uniformly aligned photo-alignment layer in a pattern representing the latent image. The photo-alignment area may be applied over the entire area of the substrate which forms the security device.

In another embodiment, the latent image may be at least partly formed by the photo-alignment layer which is applied to the substrate in a pattern representing the latent image. The liquid crystal layer can then be applied over the entire area of the device.

In a further embodiment, the latent image may be formed by a second photo-alignment layer which is applied to a uniformly aligned first photo-alignment layer covering the entire area of the device. The second alignment layer is applied, preferably by printing only, in a pattern representing the latent image, and is aligned with polarised light at a different angle to the polarised light which is used to align the uniformly aligned first photo-alignment layer. The nematic liquid crystal layer may then be applied to the second photo-alignment layer, preferably also in the pattern representing the desired latent image.

In alternative embodiments, lasers may be used to write image areas and/or non-image areas in the at least one photo-alignment layer or in the liquid crystal layer.

According to a third aspect of the invention, there is provided a method of manufacturing a liquid crystal device comprising:

applying at least one photo-alignment layer to a substrate;

uniformly polarising the photo-alignment layer with a polarised light source;

applying a liquid crystal layer to the photo-alignment layer;

wherein a latent image is formed in the at least one photo-alignment layer and/or the liquid crystal layer by writing image areas or non-image areas in at least one of said layers.

In one embodiment of this aspect of the invention, a photo-alignment layer is applied over the entire area of the substrate forming the device and is uniformly aligned with polarised light. An ultraviolet (UV) laser is used to change the photo-aligned polarisation state either in areas which are to form the latent image or in non-image areas. Preferably, the UV laser has a wavelength of 280 nm or less. The nematic liquid crystal can then be applied in a pattern representing the latent image.

In still further embodiments, a laser may be used to remove non-image areas of the uniformly aligned photo-alignment layer and/or the liquid crystal layer. The laser should be of sufficient strength so as to ablate non-image areas of the photo-alignment layer and/or the liquid crystal layer, rather than reversing the polymerisation state.

In each of the embodiments above, the liquid crystal layer may be fixed by a curing process, e.g. with UV radiation.

The polarising liquid crystal device may include further layers. For instance, in some embodiments a coating may be applied over the liquid crystal layer, preferably so as to provide a device of uniform height. Preferably, the coating has a refractive index which matches the refractive index of the liquid crystal layer to hide the latent image.

According to a further aspect of the invention, there is provided a security document incorporating a polarising liquid crystal device in accordance with the first aspect of the invention.

According to yet another aspect of the invention there is provided a polarising liquid crystal device manufactured according to either the method of the second aspect or the method of the third aspect of the invention.

According to a still further aspect of the invention there is provided a security document incorporating a liquid crystal device manufactured in accordance with either the method of the second aspect or the method of the third aspect of the invention.

As used herein, the term “security documents or tokens” includes documents such as identity documents, value documents or entrance documents, which in turn respectively include: passports, visas, identity cards, drivers licences, and security entrance cards; banknotes, shares, bounds, certificates, cheques, lottery tickets, bank cards, charge cards and credit cards; and aeroplane tickets, bus tickets, railroad tickets, and tickets to fun parks or specific rides.

The polarising liquid crystal devices of the present invention may be used to provide variable latent images of different forms in a wide variety of security documents. For example, a latent image in the form of a portrait of a cardholder may be provided in an identify card, a credit card or the like, so that the identity of the cardholder can be verified by viewing the latent image under cross-polarizers.

The present invention, which does not require separate exposures to polarised light using a mask, enables the latent image to be varied for different applications, for example, in a variable printing process and/or in a laser writing process.

Various embodiments of the present invention will now be described, by way of example only, with reference to the accompanying drawings in which:

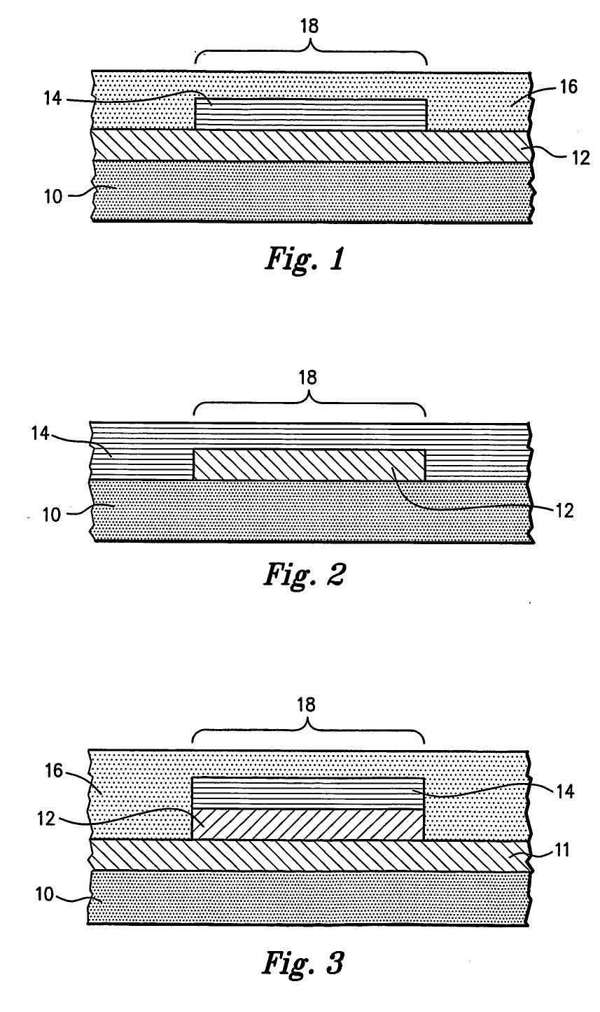

FIG. 1 is an enlarged sectional view of a first embodiment of a polarising liquid crystal device in accordance with the invention;

FIG. 2 is a perspective view of a second embodiment of a polarising liquid crystal device in accordance with the invention;

FIG. 3 is a sectional view of a third embodiment of a polarising liquid crystal device in accordance with the invention;

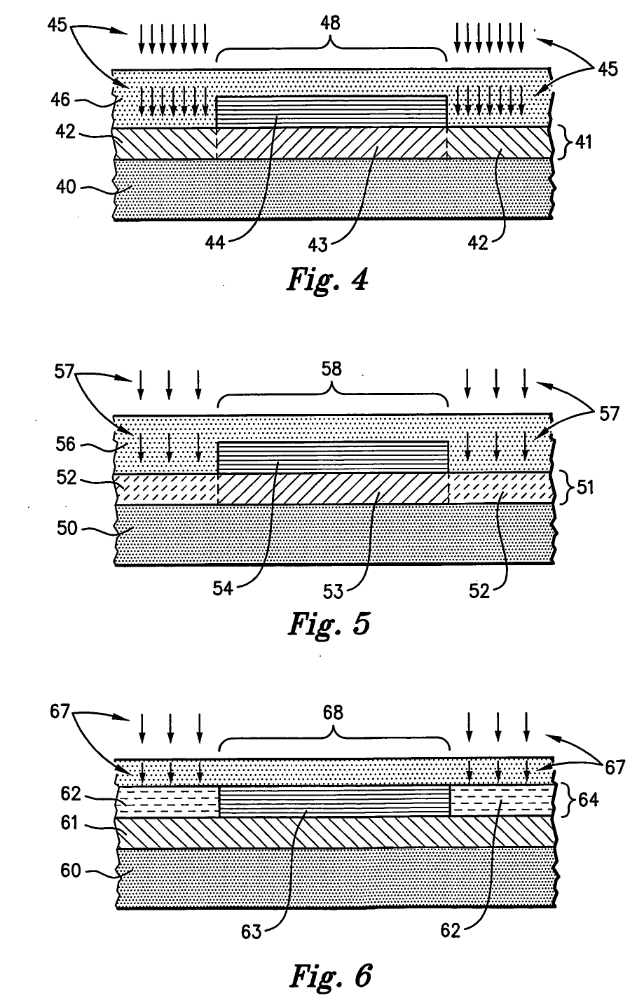

FIG. 4 is a sectional view of a fourth embodiment of a polarising liquid crystal device in accordance with the present invention;

FIG. 5 is a fifth embodiment of a polarising liquid crystal device in accordance with the invention;

FIG. 6 is a sectional view through a sixth embodiment of a polarising liquid crystal device in accordance with the invention;

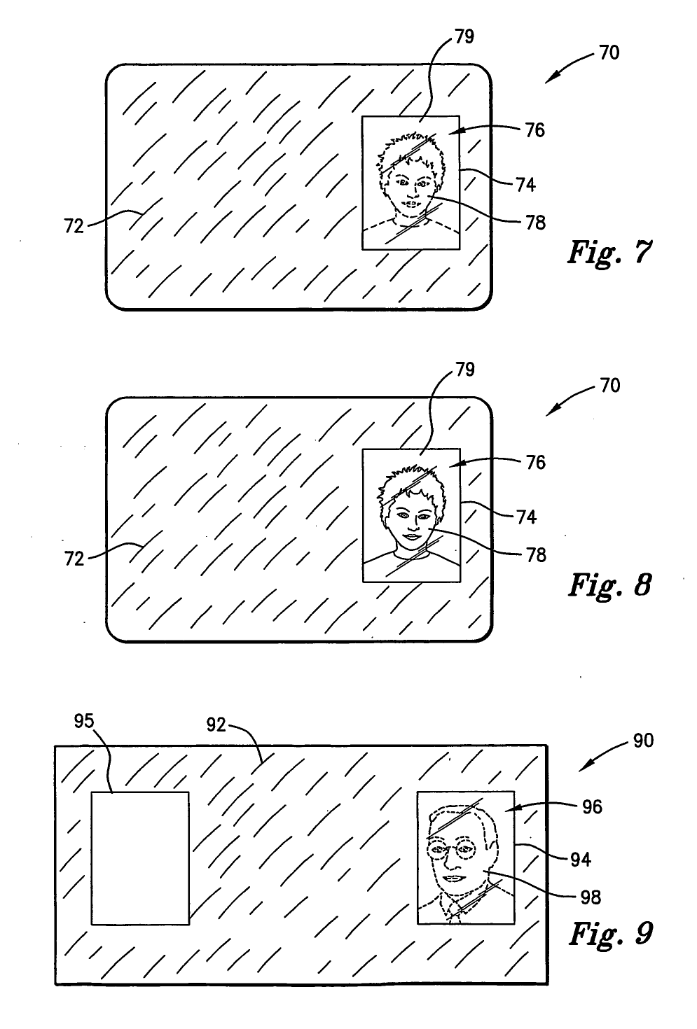

FIG. 7 is a front view of a security document in the form of an identification card including a latent image formed by a polarising liquid crystal device in accordance with the invention;

FIG. 8 is a front view of the security card of FIG. 7 when viewed through cross-polarisers; and

FIG. 9 is a front view of a flexible security document, such as a banknote, including a latent image formed by a polarising liquid crystal device with an area of cross-polarisers incorporated into the security document for verifying the latent image.

The polarising liquid crystal device shown in FIG. 1 comprises a substrate 10, an alignment layer 12, a nematic liquid crystal layer 14, and a refractive index matched coating 16.

The substrate preferably comprises a polymeric material, and more preferably comprises at least one bi-axially oriented polymeric film, such as described in WO 83/00659.

The alignment layer 12 is preferably a photo-alignment layer or orientation layer comprising a photo-orientable polymer network (PPN) of the type described in U.S. Pat. No. 5,602,661 and U.S. Pat. No. 6,160,597. The alignment layer 12 is applied to the substrate 10 to cover the entire area of the polarising liquid crystal device, preferably in a variable printing process, such as an ink jet printing process.

The nematic liquid crystal layer preferably comprises an anisotropic film of cross-linked liquid crystal monomers, such as described in U.S. Pat. No. 5,602,661 and U.S. Pat. No. 6,160,597 which is cross-linked to form a liquid crystal polymer (LCP) layer. In the embodiment of FIG. 1, the nematic liquid crystal layer 14 is applied to an image area 18 of the device in a pattern representing the desired latent image. The liquid crystal is then fixed by using UV radiation or another appropriate method of curing. In order for the image to be truly latent, the liquid crystal layer 14 and the alignment layer 12 are covered by the refractive index matched coating to hide the height aspects which would otherwise be produced by the liquid crystal layer 14 forming the latent image.

In the embodiment of FIG. 2, the alignment layer 12 is printed down on the substrate 10 only in the image area 18 in a pattern representing the latent image. The alignment layer 12 is uniformly aligned in the image area with a polarised light source. The nematic liquid crystal layer 14 is then applied over the entire area of the polarising liquid crystal device. The liquid crystal 14 is then fixed using UV radiation or another appropriate method of curing. In this embodiment, because the liquid crystal layer 14 is applied over the entire area of the device, the refractive index matched coating 16 of FIG. 1 may be omitted. However, in some applications a coating may be applied to cover the liquid crystal layer 14.

In the embodiment of FIG. 3, a first photo-alignment layer 11 is applied to the substrate 10 covering the entire area of the device, and the layer 11 is uniformly aligned with a polarised light source. A second photo-alignment layer 12 is then printed on the first alignment layer 11 only in the image area 18 of the device in a pattern representing the latent image. The second layer 12 is aligned with polarised light at a different instant angle to the first. The nematic liquid crystal layer 14 is then applied to the second alignment layer 12 in the pattern representing the desired latent image. The liquid crystal is then fixed using UV radiation or another appropriate method of curing. As in FIG. 1, a refractive index matched coating may be applied over the liquid crystal layer 14 to cover the entire area of the device to hide the height aspect otherwise produced by the layers 12 and 14.

Referring to FIG. 4, a photo-alignment layer 41 is applied to the substrate 40 to cover the entire area of the device. The layer 41 is uniformly aligned with a polarised light source. A UV laser, having a wave length of 280 nm or less is then used to “write” the non-image areas 42 into the alignment layer 41. The exposure to wave lengths of 280 nm or less can be used to reverse the photo-aligned polymerization of the alignment layer 41 in the area 42, leaving an image area 43 of the alignment layer 41 in an image area 48 of the device. The UV laser radiation is represented by arrows 45 in FIG. 4. The nematic liquid crystal layer 44 is then applied to the image area 48 in the pattern representing the desired latent image. The liquid crystal is then fixed using UV radiation or another appropriate method of curing. If the image is to be truly latent a refractive index matched coating 46 can be applied to hide the height aspect produced by the liquid crystal layer 44.

In FIG. 5, a photo-alignment layer 51 is applied to the substrate 50 covering the entire area of the device. The alignment layer 51 is uniformly aligned with a polarised light source. A laser is then used to remove non-image areas of the device outside the image area 58 by ablating non-image areas 52 leaving a non-ablated image area 53 of the alignment layer 51 in the image area 58 of the device. The laser ablation is represented by arrows 57. The nematic liquid crystal layer 54 is then applied to the non-ablated image area 53 of alignment layer 51 in the pattern representing the desired latent image. The liquid crystal is then fixed using UV radiation or another appropriate method of curing. As in FIG. 4, if the image is to be truly latent a refractive index matched coating 56 is applied over the liquid crystal layer 54 to cover the entire area of the device.

Laser ablation is used in a different manner to form the latent image in FIG. 6. In this embodiment, the photo-alignment layer is applied to the substrate 60 covering the entire area of the device. The layer 61 is uniformly aligned with a polarised light source. A liquid crystal layer 64 is then applied on the alignment layer 61 to cover the entire area of the device. A laser 67 is then used to ablate non-image areas 62 of the liquid crystal layer 64, leaving a non-ablated image area 63 of the liquid crystal layer 64 in the image area 68 of the device. As in FIGS. 4 and 5, a refractive index matched coating may be applied over the liquid crystal layer 64 in order to hide any height differences caused by the laser ablation of the liquid crystal layer 64.

In addition to this it is possible to print a uniform photo-alignment layer and then align it all one direction. A polarised UV, scanning laser is then used to destroy alignment in particular areas of the photo-alignment layer so as to produce an image in the photo alignment layer. To this, a nematic liquid crystal is applied.

FIG. 7 shows a security document in the form of an identity card 70 which includes a polarising liquid crystal device 76 which may be formed by any of the methods described with reference to FIGS. 1 to 6.

The identity card 70 is printed with indicia 72 over the entire card except in the area of a transparent window 74 in which the LC device 76 is provided. The image area 78 of the LC device 76 is shown in broken lines in FIG. 7 in the form of a portrait of a person. The non-image area 79 of the device forms a background for the portrait 78.

Under normal viewing conditions, the portrait 78 formed by the latent image of the liquid crystal device 76 is barely discernible. However, when the polarising liquid crystal device is viewed under cross-polarisers, the portrait 78 formed by the latent image of the liquid crystal device 76 becomes plainly visible. Thus, if the portrait 78 corresponds to the cardholder of the identity card 70, the correct identity of the cardholder can be verified by viewing the latent image of the liquid crystal device 76 under cross-polarisers.

A further use of polarising liquid crystal devices in accordance with the invention is illustrated by FIG. 9 which shows a security document in the form of a single flexible sheet, such as a banknote 90. The banknote 90 includes a latent image formed by a polarising liquid crystal device 96 provided in a transparent window 94 of the banknote. The latent image formed by an image area 98 of the liquid crystal device 96 is shown in the form of a portrait of a person. However, in this application the latent image may take a variety of different forms.

The flexible security document or banknote 90 is printed with indicia 92 covering the entire area of the banknote 90 except in the area of the transparent window 94 and a further transparent window 95 which includes cross-polarisers. The cross-polarisers in window 95 may be used to reveal the latent image 98 in window 94 by folding the flexible security document so that the window 95 overlies the window 94, thereby verifying the banknote.

The present invention therefore provides a polarising liquid crystal device forming a latent image which can be incorporated into a wide variety of security documents for verifying the authenticity of the security documents. The polarising liquid crystal devices can be readily manufactured using conventional variable printing technology, so that it is relatively simple to modify the latent image during manufacture to enable a wide variety of latent images to be produced for use as security devices in security documents.

It will be appreciated that various modifications may be made to the preferred embodiments described above with reference to the drawings without departing from the scope and spirit of the invention.

1. A liquid crystal device comprising:
a substrate;
at least one photo-alignment layer applied to the substrate and which is uniformly aligned with a polarized light source;
a nematic liquid crystal layer applied to the photo-alignment layer; and
a latent image formed by the photo-alignment layer and the liquid crystal layer wherein the latent image comprises a pattern formed in the at least one photo-alignment layer and/or in the liquid crystal layer without the use of a mask and the latent image is viewable under cross-polarizers.

2. A liquid crystal device comprising:
a substrate;
at least one photo-alignment layer applied to the substrate and which is uniformly aligned with a polarized light source;
a nematic liquid crystal layer applied to the photo-alignment layer; and
a latent image viewable under cross-polarizers formed in the at least one photo-alignment layer and/or the liquid crystal layer, wherein the latent image is formed by image areas and/or non-image areas written in the at least one photo-alignment layer and/or the liquid crystal layer.

3. A liquid crystal device according to claim 1 wherein a pattern forming the latent image is laser written into the photo-alignment layer and/or in the liquid crystal layer.

4. A liquid crystal device according to claim 2 wherein the latent image is formed by image areas and/or non-image areas of the photo-alignment layer and/or the liquid crystal layer removed by laser ablation.

5. A liquid crystal device according to claim 1 wherein the at least one photo-alignment layer is a printed layer.

6. A liquid crystal device according to claim 1 wherein the liquid crystal layer is a printed layer.

7. A liquid crystal device according to claim 1 wherein the photo-alignment layer is printed on the substrate in the pattern forming the latent image.

8. A liquid crystal device according to claim 1 wherein the liquid crystal layer covers the substrate in the entire area of the device.

9. A liquid crystal device according to claim 1 wherein the liquid crystal layer is printed on the photo-alignment layer in the pattern forming the latent image.

10. A liquid crystal device according to claim 9 wherein the photo-alignment layer covers the substrate in the entire area of the device.

11. A liquid crystal device according to claim 1 wherein a uniformly aligned first photo-alignment layer covers the substrate in the entire area of the device, the latent image is formed by a pattern in a second photo-alignment layer applied to the first photo-alignment layer, and the liquid crystal layer covers at least the second photo-alignment layer.

12. A liquid crystal device according to claim 11 wherein the second photo-alignment layer is printed on the first photo-alignment layer in the pattern forming the latent image.

13. A liquid crystal device according to claim 11 wherein the liquid crystal layer is applied to the second photo-alignment layer in the pattern representing the latent image.

14. A liquid crystal device according to claim 3 wherein the latent image is laser written into the at least one photo-alignment layer.

15. A liquid crystal device according to claim 11 wherein the latent image is laser-written into the second photo-alignment layer.

16. A liquid crystal device according to claim 3 wherein the latent image is laser written into the liquid crystal layer.

17. A liquid crystal device according to claim 1 wherein the liquid crystal layer is fixed by curing.

18. A liquid crystal device according to claim 1 which includes a coating over the liquid crystal layer.

19. A liquid crystal device according to claim 17 wherein the coating has a refractive index which substantially matches the refractive index of the liquid crystal layer.

20. A liquid crystal device according to claim 18 wherein the coating covers the liquid crystal layer in such a manner to provide a device of substantially uniform height.

21. A method of manufacturing a polarizing liquid crystal device comprising:
applying at least one photo-alignment layer to a substrate;
uniformly aligning the photo-alignment layer with a polarized light source;
applying a liquid crystal layer to the photo-alignment layer; and
forming a pattern representing a latent image in the at least one photo-alignment layer and/or the liquid crystal layer without the use of a mask.

22. A method according to claim 20 including the step of writing image areas and/or non-image areas in at least one of the layers.

23. A method of manufacturing a liquid crystal device comprising:
applying at least one photo-alignment layer to a substrate;
uniformly polarizing the photo-alignment layer with a polarized light source;
applying a liquid crystal layer to the photo-alignment layer; and
forming a latent image in the at least one photo-alignment layer and/or the liquid crystal layer by writing image areas or non-image areas in at least one of said layers.

24. A method according to claim 23 wherein a laser is used to write the image areas and/or non-image areas.

25. A method according to claim 24 wherein a laser is used to remove image areas or non-image areas of the at least one photo-alignment layer and/or the liquid crystal layer.

26. A method according to claim 25, wherein the uniformly aligned photo-alignment layer is applied over the substrate in the entire area of the device, and the laser is used to ablate non-image areas of the photo-alignment layer to leave non-ablated image areas.

27. A method according to claim 25 wherein the liquid crystal layer is applied to the non-ablated image areas of the photo-alignment layer in the pattern representing the latent image.

28. A method according to claim 25 wherein the laser is used to ablate non-image areas of the liquid crystal layer to leave non-ablated image areas in a pattern forming the latent image.

29. A method according to claim 24 wherein the uniformly aligned photo-alignment layer is applied over the substrate in the entire area of the device, and a UV laser is used to change the photo-alignment state of the photo-alignment layer in the image areas and/or non image areas.

30. A method according to claim 29 wherein the UV laser has a wavelength of about 280 nm or less.

31. A method according to claim 29 wherein the liquid crystal layer is applied to the photo-alignment layer in a pattern representing the latent image.

32. A method according to claim 20 including the step of printing the latent image in at least one of the layers.

33. A method according to claim 32 including the step of printing the liquid crystal layer in a pattern representing the latent image.

34. A method according to claim 33 including the step of applying the photo-alignment layer over the substrate in the entire area of the liquid crystal device before the liquid crystal layer is applied in the pattern.

35. A method according to claim 32 including the step of printing the photo-alignment layer on the substrate in a pattern representing the latent image.

36. A method according to claim 35 including the step of applying the liquid crystal area over the entire area of the liquid crystal device.

37. A method of manufacturing a polarizing liquid crystal device comprising:
applying a first photo-alignment area to cover the substrate over the entire area of the device;
uniformly aligning the first photo-alignment layer with polarized light;
applying a second photo-alignment layer in a pattern representing the latent image;
aligning the second photo-alignment layer with polarized light at an angle different to the alignment of the first photo-alignment layer; and
applying the nematic liquid crystal layer to the second alignment layer in the pattern representing the latent image.

38. A method according to claim 37 wherein the second photo-alignment is printed on the first photo-alignment layer.

39. A method according to claim 37 wherein the liquid crystal layer is printed on the second photo-alignment layer.

40. A method according to claim 21 wherein a variable printing process is used to print the at least one photo-alignment layer and/or the liquid crystal layer.

41. A method according to claim 21 further including the step of fixing the liquid crystal layer by a curing process.

42. A method according to claim 41 wherein UV radiation is used to cure the liquid crystal layer.

43. A method according to claim 21 including the step of applying a coating over the liquid crystal layer.

44. A method according to claim 43 wherein the coating has a refractive index which substantially matches the refractive index of the liquid crystal layer.

45. A method according to claim 43 wherein the coating is applied over the liquid crystal layer so as to provide a liquid crystal device of substantially uniform height.

46. A polarizing liquid crystal device manufactured by the method of claim 21.

47. A security document or token incorporating a polarizing liquid crystal device in accordance with claim 1.

48. A security document or token according to claim 47 wherein the latent image is a portrait corresponding to the holder of the security document.

49. A security document or token according to claim 47 wherein the polarizing liquid crystal device containing the latent image is provided in a window of the security document.

50. A security document or token according to claim 47 wherein the document includes cross-polarizers in a window for verifying the latent image formed by the polarizing liquid crystal device.
